(19) United States
(12) Patent Application Publication
(10) Pub. No.: US 2006/0103740 A1
(43) Pub. Date: May 18, 2006

(54) Small CCD camera and parameter setting controller

(75) Inventor: Shigehisa Igarashi, Yamagata-ken (JP)

Correspondence Address: WILLIAM L. PARADICE, III, 2686 MCALLISTER STREET, SUITE 1, SAN FRANCISCO, CA, 94118, US

(73) Assignee: Watec Co. Ltd.

(21) Appl. No.: 11/139,095

(22) Filed: May 27, 2005

(30) Foreign Application Priority Data
Nov. 15, 2004 (JP) 2004-330820

(51) Int. Cl. H04N 5/76

(52) U.S. Cl. 348/231.3

(57) ABSTRACT

A small CCD camera includes an imaging parameter setting terminal that can be connected to an external imaging parameter controller via a cable, thereby allowing the imaging parameters of the small CCD camera to be set and/or modified remotely using the external imaging parameter controller. Because the small CCD camera does not include a parameter controller, which typically includes a number of control buttons and a display, the size of the CCD camera may be minimized.

### FIELD OF THE INVENTION

The present invention relates to a small CCD camera and a parameter setting controller used for setting imaging parameters for the camera.

### DESCRIPTION OF THE RELATED ART

Conventionally, a small CCD camera is designed to be cylindrical, three dimensional, and rectangular for the external shape so that it is suitable for miniaturization, and is typically provided with a lens unit at one end portion and a power supply and video output terminal at the other end portion. In use, a cable is connected to the power supply and video output terminal and a video signal is outputted through the cable.

To minimize size, small CCD cameras typically do not include circuitry that allows a user to set or modify various imaging parameters (e.g., exposure control, color balance control, gamma characteristics, and the like) on the CCD camera. Instead, these imaging parameters are typically generated by the CCD camera's manufacturer and then loaded into the CCD camera by the manufacturer prior to shipment of the CCD camera from the manufacturer to a user. As a result, the user is typically unable to set and/or modify the imaging parameters of such small CCD cameras.

However, it is often desirable for a user to adjust the imaging parameters of the small CCD camera, for example, depending upon the intended use of the camera and/or the characteristics of objects or images desired to be captured (e.g., photographed) by the small CCD camera. Because the imaging parameters of the CCD camera cannot be adjusted by the user, to adjust the camera's imaging parameters, the user must typically return the camera to the manufacturer, which in turn disassembles the camera, changes the camera's imaging parameters using a special tool in association with color samples and the like provided by the user, and then returns the camera to the user. Thereafter, the user typically tests the small CCD camera to ensure that the adjustments to the camera's imaging parameters made by the manufacturer are acceptable to the user. If the adjustments to the camera's imaging parameters are not acceptable to the user, the user must then re-send the camera to the manufacturer for further adjustments to the camera's imaging parameters. Sending the small CCD camera back and forth between the user and the manufacturer is a time consuming process.

Therefore, there is a need for a small CCD camera whose imaging parameters can be adjusted by a user without sending the camera back to the manufacturer.

### SUMMARY OF THE INVENTION

The present invention has been made in view of such problems, and an object of the invention is to provide a small CCD camera capable of allowing a user to change the camera's imaging parameters without sending the camera back to the manufacturer. In accordance with the present invention, a small CCD camera includes a parameter setting terminal adapted to connect the camera to an external parameter setting controller via a detachable cable. The external parameter setting controller may be configured to generate and/or modify various imaging parameters for the camera, and may send the imaging parameters to the camera for storage therein via the detachable cable. Thereafter, the cable may be disconnected from the camera, for example, so that the camera may be used to capture images without being connected to the external parameter setting controller. By allowing the imaging parameters, to be sent from the external parameter setting controller to the camera via the detachable cable, the settings of the imaging parameters stored within CCD cameras of the present invention may be modified by the user without sending the camera back to the manufacturer, thereby providing an advantage over prior art small CCD cameras that must be sent back to the manufacturer to modify the imaging parameters.

Further, by sending the imaging parameters and any modifications thereto from the external parameter setting controller to the camera via the detachable cable, the camera does not need to include circuitry for generating and/or modifying the imaging parameters, thereby allowing for miniaturization of the camera. In addition, the ability to send imaging parameters from an external controller to the camera via the detachable cable allows for modifications to the camera's imaging parameters, even when the camera is not accessible by a user's hand.

For some embodiments, the parameter setting terminal may be provided separately from the camera's power supply and video output terminal. In this manner, when the camera is taking images, the power supply and the video output may be connected through a cable from the power supply and video output terminal in a manner similar to that of conventional small CCD cameras.

For some embodiments, small CCD cameras of the present invention may include a non-volatile memory for storing the imaging parameters, for example, provided by the external parameter setting controller. Further, small CCD cameras of the present invention may include a write-read unit configured to write the imaging parameters received from the external parameter setting controller via the detachable cable into the camera's non-volatile memory. The write-read unit may also be configured to read the imaging parameters from the non-volatile memory and send them to the external parameter setting controller via the detachable cable. In this manner, the imaging parameters stored in the camera's non-volatile memory may be modified and/or verified using the external parameter setting controller.

For some embodiments, the external parameter setting controller includes a display unit for displaying the imaging parameters read from the small CCD camera, and also includes a setting operation unit capable of modifying the imaging parameters for the small CCD camera. In this manner, the setting of and modifications to the camera's imaging parameters may be observed using the display unit of the external parameter setting controller.

The parameter setting controller need not supply power to the small CCD camera or receive a video output signal from the CCD camera. Since the power supply and the video output can be performed separately from the parameter setting controller, the camera may be used for capturing images without being connected to the external parameter setting controller.

### BRIEF DESCRIPTION OF THE DRAWINGS

The features and advantages of the present invention are illustrated by way of example and are by no means intended to limit the scope of the invention to the particular embodiments shown, and in which:

FIG. 1 is a perspective view of a small CCD camera and an external parameter setting controller according to some embodiments of the present invention;

FIG. 2 is a rear view of the small CCD camera of FIG. 1;

FIG. 3 is a front view of the external parameter setting controller of FIG. 1;

FIG. 4 is a top view of the external parameter setting controller of FIG. 1; and

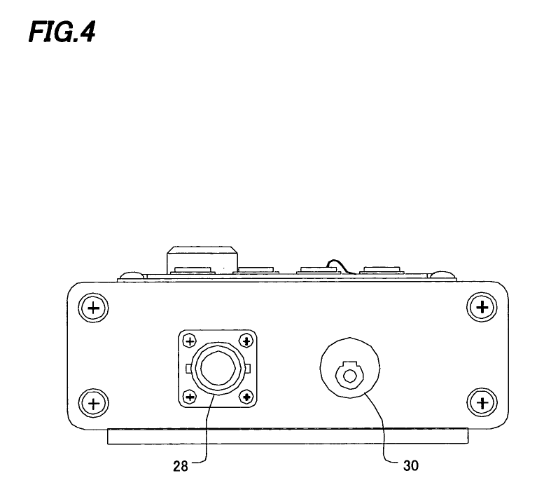

FIG. 5 is a functional block diagram of the small CCD camera of FIG. 1.

Like reference numerals refer to corresponding parts throughout the drawing figures.

### DETAILED DESCRIPTION OF THE PREFERRED EMBODIMENTS

Embodiments of the present invention are described below with respect to an exemplary small CCD camera for simplicity only. It is to be understood that embodiments of the present invention are equally applicable to other small CCD cameras. In the following description, for purposes of explanation, specific nomenclature is set forth to provide a thorough understanding of the present invention. In other instances, well-known circuits and devices are shown in block diagram form to avoid obscuring the present invention. Accordingly, the present invention is not to be construed as limited to specific embodiments described herein but rather includes within its scope all embodiments defined by the appended claims.

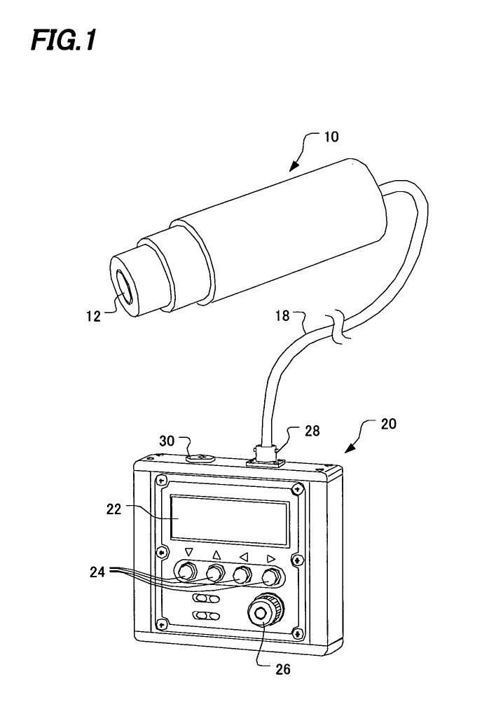

FIG. 1 is a perspective view of a small CCD camera system in accordance with some embodiments of the present invention. The camera system of FIG. 1 includes a small CCD camera 10 that may be connected to an external parameter setting controller 20 via a detachable cable 18. Although shown in FIG. 1 as cylindrically shaped, the small CCD camera 10 may, for other embodiments, be of other suitable shapes. The external dimensions of camera 10 are relatively small, for example, having a cylindrical outer diameter less than 20 mm. In this manner, the small CCD camera 10 is particularly suitable, for example, to be attached to mobile industrial equipment as a testing camera built into a testing self-propelled robot, a testing camera built into a working robot of a production line, and the like. Further, the camera 10 can be built into portions of industrial equipment and/or housing that are difficult to access by a person. Of course, the camera 10 is not limited to such exemplary applications.

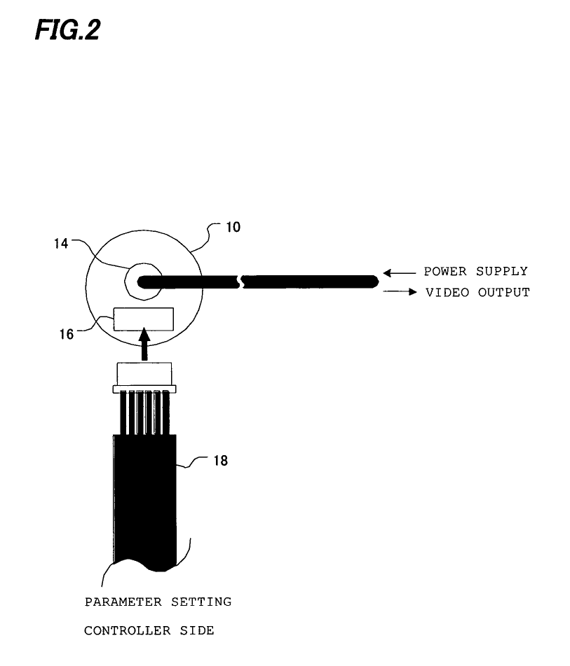

The front end portion of the cylindrical small CCD camera 10 includes a lens unit 12, and the cylindrical rear end portion thereof, as shown in FIG. 2, includes a power supply and video output terminal 14, and also includes a parameter setting terminal 16 that may be connected to the external parameter setting controller 20 via the detachable cable 18.

It is to be noted that camera 10 does not include any parameter setting buttons or an electronic display unit for displaying such parameters, thereby allowing camera 10 to be miniaturized as much as possible.

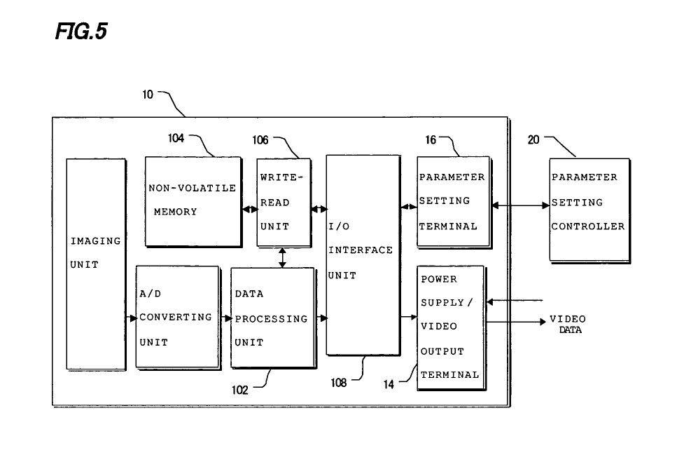

The interior of camera 10, an exemplary embodiment of which is shown in FIG. 5, includes a data processing unit 102 for software-processing an imaging signal, a non-volatile memory 104 (e.g., such as an EEPROM, flash memory, and the like) for storing imaging parameters, a write-read unit 106 for writing data to and reading data from the non-volatile memory 104, and an I/O interface unit 108 for delivering the data between the parameter setting terminal 16 and the write-read unit 106. Alternatively, the functions of the write-read unit 106 may be incorporated into the data processing unit 102 and/or into the non-volatile memory 104.

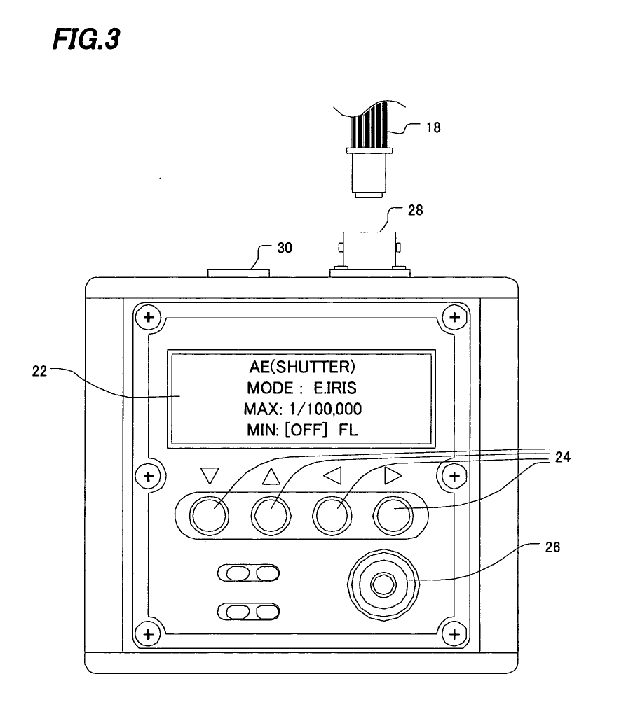

Referring to FIG. 3, the parameter setting controller 20, which is also small and portable, has a front surface that includes a liquid crystal display unit 22, item selection buttons 24, and a menu dial 26. Further, on the upper surface of the controller 20, there are a power supply terminal 30 and a camera connection terminal 28. The power supply terminal 30 may be used to provide power to controller 20 via an external power source (not shown for simplicity), and the camera connection terminal 28 may be used to connect the controller 20 to the camera via detachable cable 18. The item selection buttons 24 and the menu dial 26 constitute the setting operation unit of external controller 20. Further, inside the parameter setting controller 20, a battery unit (not shown for simplicity) may be provided to supply power when an external (e.g., commercial) power supply is not available.

The menu dial 26 may be used to set and/or modify the imaging parameters of the camera via cable 18. The imaging parameters selectable by the menu dial 26 may include, for example, an electronic iris setting, a fixed electronic shutter speed, an AGC setting, a fixing gain setting, a photometric data weighting setting, a white balance setting, a contour correction, a gamma setting, a mirror reversing, a chroma on and off, and the like.

The CCD camera 10 and the external parameter setting controller 20 are usually not connected when the camera 10 is in use. When the camera 10 is built into industrial equipment or housing and the like, after or before it is built-in, if it is desired to change the camera's imaging parameters from the initial values set by the camera manufacturer (e.g., at the time of shipment), the camera connection terminal 28 of the parameter setting controller 20 and the parameter setting terminal 16 of the CCD camera 10 may be connected by the cable 18, and while observing the liquid crystal display unit 22 of the parameter setting controller 20, the item selection buttons 24 and the menu dial 26 may be used to modify the camera's imaging parameters from the controller 20 via cable 18. Further, when the controller 20 is used to modify the imaging parameters of the camera 10 via cable 18, the power supply and video output terminal 14 may be connected to a video monitor (not shown for simplicity) so that the video monitor may be used to confirm changes to the video signal.

The imaging parameters set as described above may be inputted to the CCD camera 10 through the camera's parameter setting terminal 16 to the I/O interface unit 108, and may be written into selected addresses within the camera's non-volatile memory 104 by the write-read unit 106.

Further, the imaging parameters stored in the non-volatile memory 104 of the CCD camera 10 may be read by the write-read unit 106, and may be outputted to the parameter setting controller 20 through the camera's I/O interface unit 108 and parameter setting terminal 16 via cable 18 so that the contents of the camera's memory 104 may be displayed on the liquid crystal display unit 22 of external controller 20.

In this manner, after the setting and changing operations are completed, the cable 18 may be removed from the parameter setting terminal 16 of the CCD camera 10, and another cable may be connected to the power supply and video output terminal 14, for example, so that the CCD camera 10 may be used by itself without carrying the external parameter setting controller 20.

Thus, according to the present embodiment, because the CCD camera 10 does not include a parameter setting controller such as controller that contains the parameter setting buttons 24/26 and the electronic display unit 22 for displaying the parameters, a small external shape can be maintained for the CCD camera 10. Further, by connecting the camera 10 to the parameter setting controller 20 after the shipment of the camera from the plant, for example, in a sales store or even at the scene, the camera's imaging properties may be set and/or modified, e.g., without sending the camera back to the manufacturer. Further, even after the camera is built into industrial equipment, the parameters can be changed using the external controller 20 when connected to the camera 10 via cable 18. The ability to set and/or modify the imaging parameters of the camera 10 using external controller 20 is especially advantageous for situations in which the CCD camera 10 is difficult to access by a person (e.g., where the camera 10 is built within industrial equipment or housing). For such situations, a person need only connect the cable 18 to the camera 10 to allow the camera's imaging parameters to be set and/or modified using external controller 20.

Conversely, for prior art cameras that include a parameter setting function controller, the setting buttons, and a display screen, it may not be possible to correctly operate the buttons and confirm the imaging parameter settings if the prior art camera is deployed in a system such that its setting buttons and display are difficult to access by a person, which in turn may require removing the prior art camera from the system to change its imaging parameters. Further, because the parameter setting controller 20 of the present invention does not provide supply power current or the video output signal to the CCD camera 10, the CCD camera 10 may be used for normal functions (e.g., capturing images) without the parameter setting controller 20, thereby allowing for greater miniaturization of the camera 10.

Further, by connecting a plurality of CCD cameras 10 in order to one set of the parameter setting controller 20 via the cable 18, the setting of a plurality of CCD cameras 10 can be changed.

While the principles of the invention have been described above in connection with specific embodiments, and particular modifications thereof, it is to be clearly understood that this description is made only by way of example and not as a limitation on the scope of invention.

What is claimed is:

1. A small CCD camera, comprising:
a memory for storing one or more imaging parameters; and
a parameter setting terminal coupled to the memory and adapted to be coupled to an external parameter controller, wherein the small CCD camera is configured to receive the imaging parameters from the external parameter controller.

2. The camera of claim 1, wherein the camera does not include circuitry for generating or modifying the imaging parameters.

3. The camera of claim 1, wherein the parameter setting terminal of the camera is coupled to the external parameter controller via a detachable cable.

4. The camera of claim 1, wherein the external parameter controller is configured to generate the imaging parameters.

5. The camera of claim 1, wherein the external parameter controller is disconnected from the camera when the camera is used for capturing images.

6. The camera of claim 1, wherein the memory comprises a non-volatile memory.

7. The camera of claim 1, further comprising:
a power supply and video output terminal for providing power to the camera and for outputting a video signal from the camera, wherein the power supply and video output terminal are separate from the parameter setting terminal.

8. The camera of claim 1, further comprising:
a write-read unit coupled to the memory and to the parameter setting terminal, the write-read unit configured to write the imaging parameters received from the external parameter controller to the memory, and configured to read the imaging parameters from the memory for output to the external parameter controller via the parameter setting terminal.

9. A camera system, comprising:
a small CCD camera having a memory for storing one or more imaging parameters, and having a parameter setting terminal coupled to the memory;
a detachable cable having a first end adapted to be connected to the parameter setting terminal, and having a second end; and
a parameter controller having a terminal coupled to the second end of the cable and configured to send the imaging parameters to the camera via the detachable cable, wherein the parameter controller is external to the camera.

10. The camera system of claim 9, wherein the camera does not include circuitry for generating or modifying the imaging parameters.

11. The camera system of claim 9, wherein the external parameter controller is configured to generate and/or modify the imaging parameters.

12. The camera system of claim 9, wherein the camera further comprises:
a write-read unit coupled to the memory and to the parameter setting terminal, the write-read unit configured to write the imaging parameters received from the external parameter controller via the detachable cable to the memory, and configured to read the imaging parameters from the memory for output to the external parameter controller, via the detachable cable.

13. The camera system of claim 12, wherein the parameter controller comprises:
a setting operation unit configured to generate and modify the imaging parameters to be stored in the camera's memory.

14. The camera system of claim 13, wherein the parameter controller further comprises:
a display unit configured to display the imaging parameters read from the camera' memory via the detachable cable.

15. The camera system of claim 9, wherein the camera further comprises:
a power supply and video output terminal for providing power to the camera and for outputting a video output signal from the camera, wherein the power supply and video output terminal are separate from the parameter setting terminal.

16. A method of operating a small CCD camera, the method comprising:
generating a set of imaging parameters in a controller external to the camera;
connecting a detachable cable between the camera and the external controller;
transmitting the imaging parameters from the external controller to the camera via the detachable cable; and
storing the imaging parameters in a memory provided within the camera.

17. The method of claim 16, further comprising:
disconnecting the detachable cable from the camera; and
capturing images using the camera without the camera being connected to the external controller.

18. The method of claim 17, further comprising:
re-connecting the detachable cable between the camera and the controller;
modifying the imaging parameters in the external controller;
transmitting the modified imaging parameters from the external controller to the camera via the detachable cable; and
storing the modified imaging parameters in the camera's memory.

19. The method of claim 17, further comprising:
re-connecting the cable between the camera and the controller;
sending the imaging parameters from the camera to the external controller via the detachable cable; and
displaying the imaging parameters on a display provided on the external controller.

20. The method of claim 16, wherein the imaging parameters are not generated in the camera.
